(19) United States
(12) Patent Application Publication
(10) Pub. No.: US 2024/0210345 A1
(43) Pub. Date: Jun. 27, 2024

(54) System and Method for Detecting Condensing Humidity and/or Impurities in an Electronic Device

(71) Applicant: KSB SE & Co. KGAA, Frankenthal (DE)

(72) Inventors: Federico DI SANTO, Sossano (VI) (IT); Giancarlo VERLATO, Sossano (VI) (IT)

(21) Appl. No.: 18/287,558

(22) PCT Filed: Apr. 5, 2022
(86) PCT No.: PCT/IB2022/053146

§ 371 Date: Oct. 19, 2023

(30) Foreign Application Priority Data
Apr. 20, 2021 (IT) 102021000009959

(51) Int. Cl. G01N 27/22

(52) U.S. Cl. CPC G01N 27/223

(57) ABSTRACT

A system configured to detect condensing humidity and/or impurities includes an electronic device, a humidity sensor, and an electronic control unit. The electronic control unit is configured to issue a pre-alarm or an alarm when said instantaneous condensing humidity value exceeds said first threshold value. The humidity sensor comprises two or more conductive tracks. The two or more conductive tracks are configured to form an equivalent capacitive circuit and are distributed over said free surface portion of said circuit board.

### CROSS REFERENCE TO RELATED APPLICATIONS

This application claims priority under 35 U.S.C. § 119 from Italian Patent Application No. 102021000009959, filed Apr. 20, 2021, the entire disclosure of which is herein expressly incorporated by reference.

### BACKGROUND

The present disclosure generally relates to humidity detection and particularly relates to a system for detecting condensing humidity and/or impurities in an electronic device.

The disclosure further relates to a method of detecting condensing humidity and/or impurities in an electronic device.

Electronic equipment has been long known to be highly sensitive to moisture derived, for example, from wrong installation of an electronic device or from neglected maintenance.

Generally, excessive condensing humidity values or impurities on the electronic circuits of a device even with as low a supply voltage as a few tens of volts may lead to the failure of the power and/or signal components of the circuit board of the device.

Typically, protection against condensing humidity and impurities is provided by applying special paints or resins to waterproof highly moisture-sensitive components of the circuit board.

However, this type of application is not able to protect power supply contact points, which must be necessarily exposed, or the solder pins of the interconnections with other circuits or wiring, as paints and resins rise up their surfaces via capillary action, thereby covering and isolating the connection points.

In an attempt to at least partially obviate this drawback, the electronic device to be protected is installed in highly electrically insulated containers, normally with IP55 or IP56 and preferably with the use of watertight containers having an IP67 or IP68 degree of insulation.

Nevertheless, the above-discussed solutions are highly expensive and often do not afford complete and long-lasting protection, for example, in case of wrong installation, such as poor tightening of the glands or with presence of aggressive or corrosive agents in the environment which affect the state of the seals over time.

In an attempt to at least partially obviate these drawbacks, systems have been developed which have at least one humidity sensor associated with an electronic control unit equipped with a memory unit, and which are designed to measure humidity to predict the mechanical failures of the electronic device to be protected.

WO2012172048 discloses a system for monitoring humidity inside an inverter. The system comprises an inverter having a humidity sensor located inside its casing, a microcontroller connected to the humidity sensor and a heating member connected to the microcontroller.

The humidity sensor is of conventional type and comprises a dielectric and a pair of armatures adapted to form a capacitive circuit whose capacitance varies with humidity. When the sensor detects a humidity value above a predetermined threshold value, the microcontroller turns on the heating member to decrease the humidity value inside the inverter.

A first drawback of this known solution is that the provision of the heating member affords automatic decrease of humidity inside the inverter without warning the user that a humidity aggregation problem exists.

As a result, a user can only ascertain the presence of excessive humidity caused by wrong installation of the electronic device or neglected by periodic checks on the electronic device.

A second drawback of this known solution is that the humidity sensor detects the presence of humidity only in the area in which it is installed and the electronic device requires a large number of sensors to protect the entire electronic device.

A further drawback is that the humidity sensor only detects the presence of humidity and not the presence of other potentially conductive agents, such as oils and environmental impurities.

Another serious drawback of this known solution is that it affords detection of the humidity level but not of the condensing humidity on the electric circuit of the electronic device to be protected. This is because condensing humidity, also known as the dew point, depends on many factors such as temperature and pressure, and not only on the humidity level.

### SUMMARY

Accordingly, there is a need to develop a system and a method for detecting condensing humidity at the very start, i.e. with the first signs of aggregation and not limited to water vapor.

In light of the prior art, the technical problem addressed by the present disclosure is to afford intelligent detection of any condensing humidity anomaly in an electronic device and provide indication of abnormal operation and malfunctioning while avoiding false alarms and providing preventive maintenance.

The object of the present disclosure is to obviate the above discussed drawback, by providing a system and a method for detecting condensing humidity and/or impurities in an electronic device, that are highly efficient and cost-effective.

A particular object of the present disclosure is to provide a system and a method for detecting humidity and/or impurities as described above, that avoid false alarms.

A further object of the present disclosure is to provide a system and a method for detecting conducting impurities not limited to water vapor.

Another object of the present disclosure is to provide a system and a method for detecting humidity and/or impurities as described above that can recognize excessive humidity and conducting impurities derived from wrong installation of the electronic device or from neglected maintenance.

A further object of the present disclosure is to provide a system and a method for detecting humidity and/or impurities as described above that can identify a pre-alarm threshold and a stop threshold for stopping condensing humidity incompatible with the electronic circuits of the device.

Another object of the present disclosure is to provide a system and a method for detecting the presence of humidity and/or impurities as described above that afford installation of humidity sensors on strategic locations of the electronic device to detect microenvironment humidity and react to the first 3 signs of aggregation.

Yet another object of the present disclosure is to provide a system and a method for detecting humidity and/or impurities as described above that afford installation of sensors all over the possible useful surface of the PCB, to detect microenvironment humidity and react to the first signs of aggregation.

These and other objects, as more clearly explained hereafter, are fulfilled by a system for detecting condensing humidity and/or impurities in an electronic device as defined in claim 1, wherein the device comprises a circuit which has at least one circuit board having a plurality of electrical or electronic components installed on its surface and a free surface portion not occupied by electronic components.

The system of the disclosure comprises a humidity sensor for measuring the instantaneous condensing humidity value on the electronic circuit of the device and an electronic control unit operatively associated with a memory unit which stores at least one first humidity threshold value.

The electronic control unit is configured to issue a pre-alarm or an alarm when the instantaneous condensing humidity value exceeds the first threshold value.

According to a particular aspect of the disclosure, the humidity sensor comprises two or more conductive tracks configured to form a capacitive equivalent circuit and arranged on the free surface portion of the circuit board. Furthermore, the humidity sensor comprises two or more conductive tracks configured to form a capacitive circuit and arranged on most of the free surface portion of the circuit board.

This combination of characteristics affords increased sensitivity in condensing humidity and/or impurity detection since the first signs of aggregation by maximizing the extent of its conductive tracks in the free surface portion of the circuit board of the device.

The disclosure also relates to a method for detecting condensing 30 humidity and/or impurities in an electronic device by indicating that predetermined humidity thresholds, incompatible with the electronic circuit of the device, have been exceeded, as defined in claim 8.

Advantageous embodiments of the disclosure are as defined in the dependent claims.

Further features and advantages of the disclosure will be more apparent from the detailed description of a preferred, non-exclusive embodiment of a system and a method for detecting condensing humidity and/or impurities in an electronic device, which are described as a non-limiting example with the help of the annexed drawings, in which:

### BRIEF DESCRIPTION OF THE DRAWINGS

FIGS. 1A-1B are a schematic view of the system of the disclosure;

FIG. 2 is a schematic view of a detail of the system of FIG. 1B; and

FIG. 3 is a block diagram of the inventive method.

### DETAILED DESCRIPTION

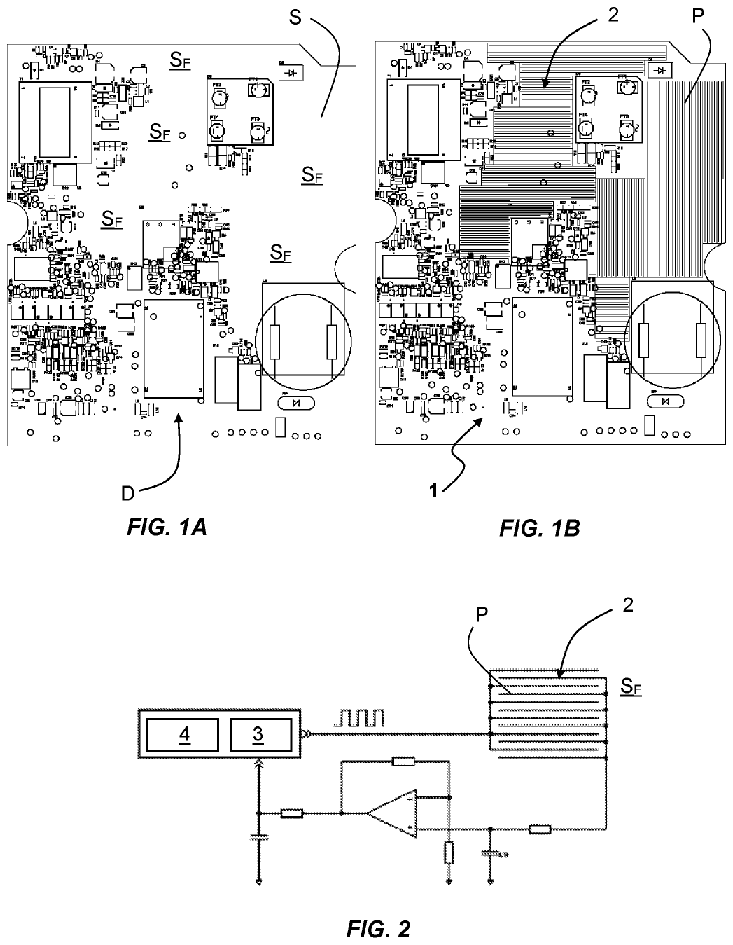

Particularly referring to the figures, there is shown a system 1 for detecting condensing humidity and/or impurities in an electronic device D, as best shown in FIGS. 1A and 1B.

As used herein, “electronic device” refers to any device having an electronic circuit with power and/or signal elements, such as an inverter, a power or signal driver or a similar apparatus.

As is well known, the electronic device D comprises an electronic circuit having at least one circuit board which has a plurality of electrical or electronic components installed on its surface S and a free surface portion SF not occupied by such electronic components, as best shown in FIG. 1A.

In a preferred embodiment of the disclosure, the system 1 comprises a humidity sensor 2 for measuring the instantaneous condensing humidity value UL on the electronic circuit of the device D and an electronic control unit 3 operatively associated with a memory unit 4 which stores at least one first humidity threshold value UA1.

Preferably, the humidity sensor 2, the electronic control unit 3 and the memory unit 4 may be incorporated in the circuit board of the electronic device 30 D.

As an alternative, the humidity sensor 2 can be incorporated in the circuit board of the electronic device D and the electronic control unit 3 and the 5 memory unit 4 may be independent of the circuit board and installed in a casing of the electronic device D as long as they are directly connected thereto.

Advantageously, the electronic control unit 3 is configured to issue a pre-alarm when the instantaneous condensing humidity value UL as measured by the humidity sensor 2 exceeds the first threshold value UA1.

In addition, the memory unit 4 stores at least one second reference humidity value UA2 which is greater than first reference humidity value UA1 and therefore the electronic control unit 3 is configured to issue an alarm if the instantaneous condensing humidity value as measured UL exceeds the second reference humidity value UA2.

As used herein, “pre-alarm” refers to a warning aimed at avoiding downtime and useful to request a check on the electronic device D by the personnel.

According to a peculiar aspect of the disclosure, the humidity sensor 2 15 comprises two or more conductive tracks P arranged on the free surface portion SF of the circuit board and configured to form a capacitive circuit, as best shown in FIG. 1B.

This will allow condensing humidity or impurities to be detected since the first signs of aggregation and without implementing individual humidity 20 sensors, but by maximizing the extent of the conductive tracks in the free surface portion of the circuit board of the device D.

Therefore, the circuit board of the device D may be deemed as a single humidity and/or impurity sensor by having its two or more conductive tracks P arranged wherever possible over the free surface portion SF.

Furthermore, the particular conformation of the capacitive equivalent circuit affords detection of both humidity and other potentially conducting agents, such as oils and environmental impurities.

Namely, the conductive tracks P are supplied with AC voltage at a predetermined frequency, which may change over time or be fixed and selectively configurable.

Also, the conductive tracks P have time-varying capacitance and potential difference values that can be measured by the electronic control unit 3 to be able to issue the pre-alarm or alarm.

Of course, the system 1 comprises appropriate filters and amplification circuits for filtering and/or amplifying the instantaneous condensing humidity value uL as measured by the humidity sensor 2, as best shown in FIG. 2.

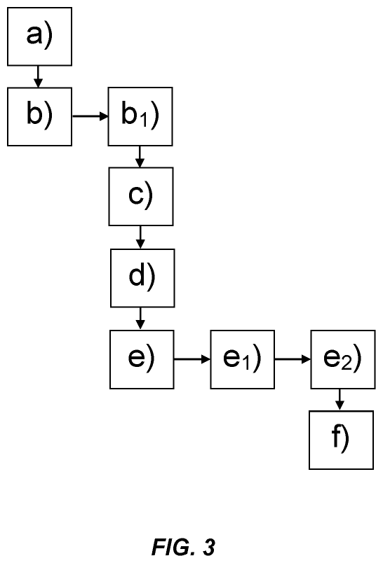

In a further aspect, the disclosure provides a method, as schematically shown in FIG. 3, for detecting condensing humidity and/or impurities in an electronic device D by indicating that predetermined humidity thresholds incompatible with the electronic circuit of the device D have been exceeded, wherein the device D comprises a circuit that has at least one circuit board having a plurality of electrical or electronic components installed on its surface S and a free surface portion SF not occupied by electronic components.

The method includes a first step of a) providing at least one humidity sensor 2 operably associable with an electronic control unit 3 equipped with a memory unit 4, as shown in FIG. 2.

The step a) is followed by a step of b) predetermining and storing at least one first humidity threshold value uA1 in the memory unit 4 and a step of c) actuating the electronic device D and the electronic control unit 3.

The following step is a step of d) measuring the instantaneous condensing humidity uL on the electronic circuit of the device D by the sensor 2.

This is followed by a step of e) issuing a pre-alarm or alarm signal by the electronic control unit 3 when the instantaneous condensing humidity value uL exceeds the first humidity threshold value uA1.

Advantageously, the step e) of issuing comprises a step of e1) issuing a pre-alarm when the instantaneous condensing humidity value uL as measured in step d) exceeds the first humidity threshold value uA1, and a step of e2) issuing an alarm when the instantaneous condensing humidity value uL as measured in step d) exceeds a second humidity threshold value uA2 that is greater than the first reference humidity value uA1.

It will be appreciated that the method as described heretofore is able to calibrate the monitored system on the specific application. That is, it can check whether the instantaneous humidity uL as measured during step d) is higher than the one that has been predicted and stored in step b).

In particular, the step b) of storing is associated with a step of b1) predetermining a maximum persistence time tA of the instantaneous condensing humidity uL.

Thus, a step is provided of f) stopping the electronic device D when the instantaneous condensing humidity value uL as measured in step d) exceeds a second humidity threshold value uA2 for a persistence time that exceeds than the maximum persistence time value tA.

Therefore, if the instantaneous humidity value uL exceeds the second humidity threshold value uA2 and if its persistence time tL exceeds the maximum persistence time value tA, then the electronic control unit 3 stops the electronic device D.

Furthermore, if the instantaneous humidity value uL exceeds the second humidity threshold value uA2 for a persistence time tL that exceeds the maximum persistence time tA, even though the instantaneous humidity value uL is within the range that can be determined by the relation uA1<uL<uA2, an alarm signal is maintained until the condensate is removed or evaporated and a reset is made by the maintenance personnel.

By this arrangement, the above described method provides preventive maintenance before any disastrous aggregation of condensing humidity might damage or permanently jeopardize the operation of the electronic device D.

Advantageously, a computer program is installed in the control unit 2 comprising program codes adapted to carry out the steps c)-f) of the method.

It will be appreciated that the method of the disclosure can recognize the presence of excessive humidity detrimental to the electronic circuits of the device D, which can be caused by wrong installation and by neglected maintenance of the electronic device D or by hardly predictable or totally unpredictable external environmental phenomena.

It will be appreciated from the foregoing that the method and the system for detecting humidity in an electronic device according to the disclosure fulfill the intended objects and namely allow indication of any abnormal operation and malfunctioning while avoiding false alarms and providing preventive maintenance.

The system and method of the disclosure are susceptible to a number of changes or variants, within the inventive concept disclosed in the annexed claims.

While the system and method have been described with particular reference to the accompanying figures, the numerals referred to in the disclosure and claims are only used for the sake of a better intelligibility of the disclosure and shall not be intended to limit the claimed scope in any manner.

Reference herein to “one embodiment” or “the embodiment” or “some embodiments” indicates that a particular characteristic, structure or member that is being described is included in at least one embodiment of the inventive subject matter.

Furthermore, the particular characteristics, structures or members may be combined together in any suitable manner to provide one or more embodiments.

### INDUSTRIAL APPLICABILITY

The present disclosure may find application in industry, because it can be produced on an industrial scale in factories manufacturing electronic control devices.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof

1-11. (canceled)

12. A system configured to detect condensing humidity and/or impurities, comprising:
an electronic device, which comprises a circuit having at least one circuit board which has a plurality of electrical or electronic components installed on its surface and a free surface portion not occupied by said electronic components;
a humidity sensor configured to measure an instantaneous condensing humidity value on the electronic circuit of the device; and
an electronic control unit operatively associated with a memory unit on which at least one first humidity threshold value is stored, wherein
said electronic control unit is configured to issue a pre-alarm or an alarm when said instantaneous condensing humidity value exceeds said first threshold value, and
said humidity sensor comprises two or more conductive tracks configured to form an equivalent capacitive circuit distributed over said free surface portion of said circuit board.

13. The system as claimed in claim 12, wherein said conductive tracks are supplied with AC voltage at a predetermined frequency, which is variable over time or is fixed, and selectively configurable.

14. The system as claimed in claim 12, wherein said two or more conductive tracks have time-varying capacitance and potential difference values that are measurable by said electronic control unit.

15. The system as claimed in claim 12, wherein at least one second reference humidity value is greater than said first reference humidity value and is stored in said memory unit, and said electronic control unit is configured to issue an alarm if the instantaneous condensing humidity value exceeds said second reference humidity value.

16. The system as claimed in claim 12, further comprising:
suitable filters and amplification circuits for filtering and/or amplifying the instantaneous condensing humidity value as measured by said humidity sensor.

17. The system as claimed in claim 12, wherein said humidity sensor, said electronic control unit, and said memory unit are incorporated in said circuit board.

18. The system as claimed in claim 12, wherein said electronic control unit and said memory unit are independent from said circuit board and are installed in a casing of said electronic device.

19. A method of detecting condensing humidity and/or impurities in an electronic device by indicating that predetermined humidity thresholds incompatible with the electronic circuit of the device have been exceeded, wherein the device comprises a circuit that has at least one circuit board on which a plurality of electrical or electronic components are installed on its surface and a free surface portion not occupied by said electronic components, the method comprising the steps of:
providing at least one humidity sensor operatively associable with an electronic control unit equipped with a memory unit;
predetermining and storing at least one first humidity threshold value in said memory unit;
actuating the device and the electronic control unit;
measuring, by said sensor, the instantaneous condensing humidity value on the electronic circuit of the device; and
issuing a pre-alarm or alarm signal by said electronic control unit when said instantaneous condensing humidity value exceeds said first humidity threshold value; wherein
said humidity sensor comprises two or more conductive tracks which are arranged over said free surface portion of said circuit board and are configured to operate as an equivalent capacitive circuit.

20. The method as claimed in claim 19, wherein said step of issuing further comprises a step of issuing a pre-alarm when the instantaneous condensing humidity value as measured in said step of measuring exceeds said first humidity threshold value and a step of issuing an alarm when the instantaneous condensing humidity value as measured in said step of measuring exceeds a second humidity threshold value that is greater than said first reference humidity value.

21. The method as claimed in claim 20, wherein said step predetermining and storing is associated with a step of predetermining a maximum persistence time of the instantaneous condensing humidity value.

22. The method as claimed in claim 21, further comprising: a step of stopping the electronic device when the instantaneous condensing humidity value as measured in said step of measuring exceeds a second humidity threshold value for a persistence time greater than said maximum persistence time value.
